(19) United States
(12) Patent Application Publication
(10) Pub. No.: US 2014/0196256 A1
(43) Pub. Date: Jul. 17, 2014

(54) CORD TENSIONING AND SECURING DEVICE

(71) Applicant: Brent A. Garcia, Las Vegas, NV (US)

(72) Inventor: Brent A. Garcia, Las Vegas, NV (US)

(21) Appl. No.: 14/152,077

(22) Filed: Jan. 10, 2014

Related U.S. Application Data
(60) Provisional application No. 61/751,479, filed on Jan. 11, 2013.

(51) Int. Cl. F16G 11/04; F16G 11/14

(52) U.S. Cl. CPC F16G 11/046; F16G 11/14
USPC 24/129 R

(57) ABSTRACT

A cord tensioning and securing device including an elongated body including a proximal end, a distal end, a top surface, bottom surface, a left surface, a right surface, at least one indentation disposed on the top surface configured to allow at least a portion of a cord to be engaged therein, and at least one recess disposed through the bottom surface configured to allow at least a portion of a cord to be engaged therein.

### CROSS REFERENCE TO RELATED APPLICATIONS

The present application is related to, and claims the priority benefit of, U.S. Provisional Patent Application Ser. No. 61/751,479 filed Jan. 11, 2013, the contents of which are hereby incorporated in their entirety into the present disclosure

### BACKGROUND

There are many devices used for fastening and securing objects using ropes or cords. In some instances, a paracord may be used. Paracord (also parachutecord or 550 cord) is a lightweight nylon cord. Generally, a paracord has an interior core made up of 7 individually twisted strands covered by a woven exterior sheath.

A common way of securing and tighten a rope or paracord is by way of joining or securing lengths of rope or paracord; then, tying the material together or around itself. While often effective, skill in tying the material together or around itself and proper selection of a particular configuration for a particular purpose is required. Poorly tying the material together or around itself, or the use of an incorrect configuration may allow the rope or paracord to slip or make the tied material difficult to untie.

There is, therefore, a need for a device used to tighten and secure ropes and paracords without having to tie the rope or paracord together or around itself.

### SUMMARY

In one aspect, a cord tensioning and securing device is provided. The cord tensioning and securing device includes an elongated body including a proximal end, a distal end, a top surface, a bottom surface, a left surface, and a right surface. The elongated body may be constructed of a rigid material. In at least one embodiment, the elongated body includes a length dimension extending between the proximal end to the distal end, a height dimension extending between the bottom surface to the top service, and a width dimension extending between the left surface to the right surface. In at least one embodiment the length dimension may be less than or equal to approximately 3.0 inches. In at least one embodiment, the height dimension may be less than or equal to approximately 1.5 inches. In at least one embodiment, the width dimension may be less than or equal to approximately 0.5 inch. The cord tensioning and securing device further includes at least one aperture disposed in the elongated body. In at least one embodiment, the at least one aperture penetrates through the left surface and the right surface. In at least one embodiment, the at least one aperture may be disposed in proximity to the proximal end. In at least one embodiment, the at least one aperture is disposed in proximity to the distal end. In at least one embodiment, the distal end includes a curvature extending from the top surface to the bottom surface.

In at least one embodiment, the cord tensioning and securing device further includes at least one indentation disposed on the top surface. In at least one embodiment, the cord tensioning and securing device further includes at least one recess disposed through the bottom surface. In at least one embodiment, the at least one recess forms at least one protrusion on the bottom surface. In at least one embodiment, the at least one protrusion may be biased towards the proximal end. In at least one embodiment, the at least one protrusion may be biased towards the distal end.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a perspective view of a cord tensioning and securing device according to at least one embodiment of the present disclosure;

FIG. 2 is a side view of a cord tensioning and securing device according to at least one embodiment of the present disclosure;

FIG. 3 is a side view of a cord tensioning and securing device according to at least one embodiment of the present disclosure; and

FIG. 4 is a perspective view of a cord in use with a cord tensioning and securing device according to at least one embodiment of the present disclosure.

### DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

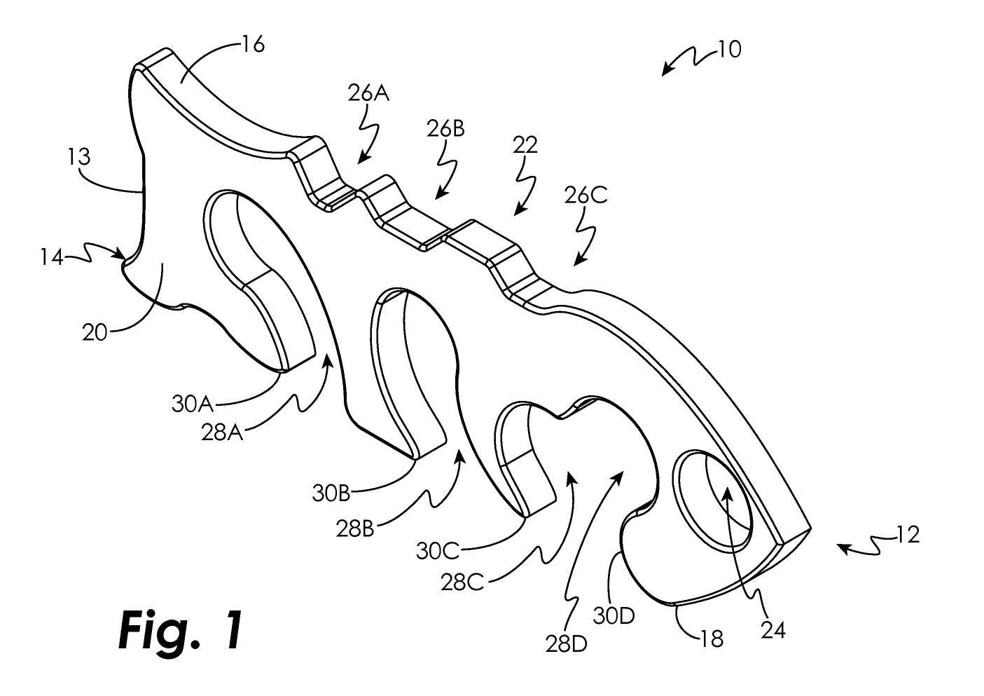

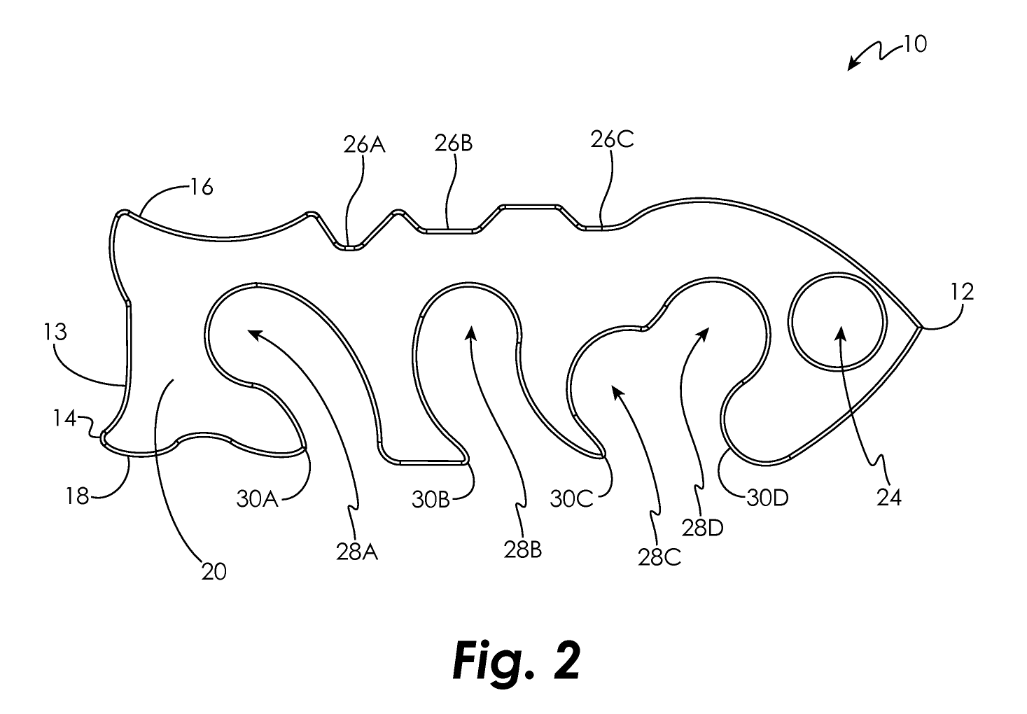

FIGS. 1 and 2 illustrate a cord tensioning and securing device according to at least one embodiment of the present disclosure, indicated generally at 10. The cord tensioning and securing device 10 includes an elongated body including a proximal end 12, a distal end 14, a top surface 16, a bottom surface 18, a left surface 20, and a right surface 22. The elongated body may be constructed of a rigid material, including aluminum, stainless steel, or titanium to name a few non-limiting examples. In at least one embodiment, the elongated body includes a length dimension extending between the proximal end to the distal end, a height dimension extending between the bottom surface to the top service, and a width dimension extending between the left surface to the right surface. In at least one embodiment the length dimension may be less than or equal to approximately 3.0 inches. In at least one embodiment, the height dimension may be less than or equal to approximately 1.5 inches. In at least one embodiment, the width dimension may be less than or equal to approximately 0.5 inch. The cord tensioning and securing device 10 further includes at least one aperture 24 disposed in the elongated body. In at least one embodiment, the at least one aperture 24 penetrates through the left surface 20 and the right surface 20. In at least one embodiment, the at least one aperture 24 may be disposed in proximity to the proximal end 12. In at least one embodiment, the at least one aperture 24 may be disposed in proximity to the distal end 14. In at least one embodiment, the distal end includes a curvature 13 extending substantially from the top surface 16 to the bottom surface 18.

The cord tensioning and securing device 10 further includes at least one indentation 26 disposed on the top surface 16. The at least one indentation 26 may be used to produce improved engagement and tension of the paracord while a user is attempting to secure the cord. For example, as shown in FIGS. 1 and 2, the at least one indentation 26 includes three indentations 26A-C disposed in a non-uniform shape and a non-uniform orientation along the top surface 16. It will also be appreciated that the indentations may be in a uniform shape and/or uniform orientation along the top surface 16.

The cord tensioning and securing device 10 further includes at least one recess 28 disposed through the bottom surface 18. The at least one recess 28 may be used to produce improved engagement and tension of a paracord while a user is attempting to secure the cord. For example, as shown in FIGS. 1 and 2, the at least one recess 28 includes four recesses 28A-D disposed in a non-uniform shape and a non-uniform orientation through the bottom surface 18. It will also be appreciated that the recesses may be in a uniform shape and/or uniform orientation through the bottom surface 18. In at least one embodiment, the at least one recess 28 forms at least one protrusion 30 on the bottom surface 18. In at least one embodiment, the at least one protrusion 30 may be biased towards the proximal end 12. In at least one embodiment, the at least one protrusion 30 may be biased towards the distal end 14. For example, as shown in FIGS. 1 and 2, the cord tensioning and securing device 10 includes protrusions 30A-C that are biased towards the proximal end 12, and includes protrusion 30D biased towards the distal end 14.

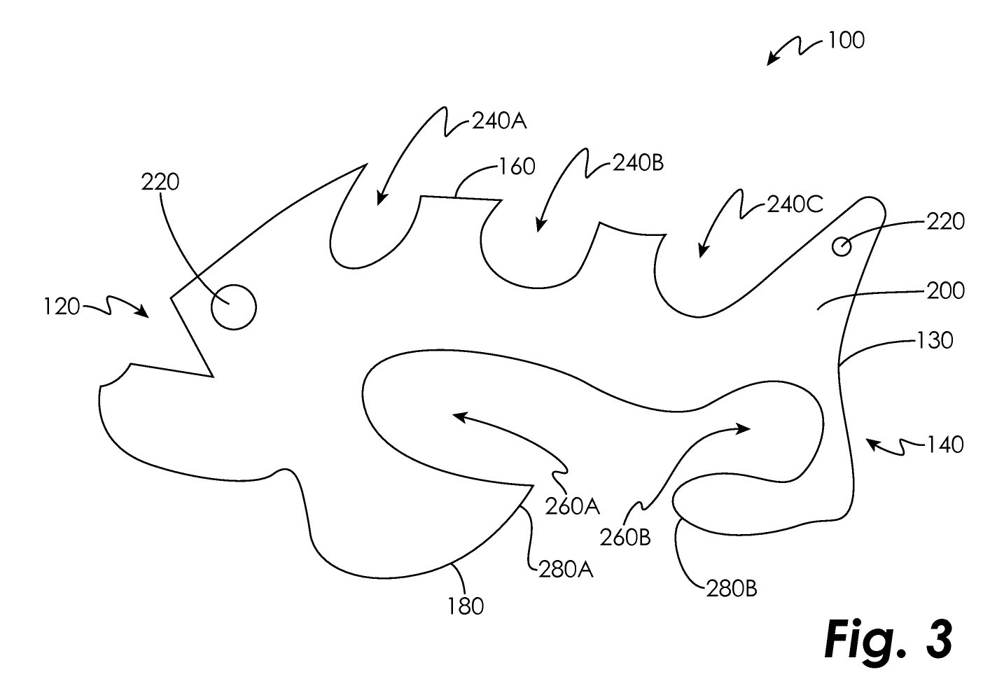

FIG. 3 illustrates a side view of a cord tensioning and securing device of the present disclosure, indicated generally at 100. The cord tensioning and securing device 100 includes an elongated body including a proximal end 120, a distal end 140, a top surface 160, a bottom surface 180, a left surface 200, and a right surface (not shown). The elongated body may be constructed of a rigid material, including aluminum, stainless steel, or titanium to name a few non-limiting examples. In at least one embodiment, the elongated body includes a length dimension, a height dimension, and a width dimension. In at least one embodiment the length dimension may be less than or equal to approximately 3.0 inches. In at least one embodiment, the height dimension may be less or equal to approximately 1.5 inches. In at least one embodiment, the width dimension may be less than or equal to approximately 0.5 inch. The cord tensioning and securing device 100 further includes at least one aperture 220 disposed in elongated body. In at least one embodiment, the at least one aperture 220 penetrates through the left surface 200 and the right surface (not shown). In at least one embodiment, the at least one aperture 220 is disposed in proximity to the proximal end 120. In at least one embodiment, the at least one aperture 220 is disposed in proximity to the distal end 140. In at least one embodiment, the distal end includes a curvature 130 extending from the top surface 160 to the bottom surface 180.

The cord tensioning and securing device 100 further includes at least one indentation 240 disposed on the top surface 160. The at least one indentation 240 may be used to produce improved engagement and tension of the paracord while a user is attempting to secure the cord. For example, as shown in FIG. 3, the at least one indentation 240 includes three indentations 240A-C disposed in a non-uniform shape and a non-uniform orientation along the top surface 160. It will also be appreciated that the indentations may be in a uniform shape and/or uniform orientation along the top surface 160.

The cord tensioning and securing device 100 further includes at least one recess 280 disposed through the bottom surface 180. The at least one recess 260 may be used to produce improved engagement and tension of the paracord while a user is attempting to secure the cord. For example, as shown in FIG. 3, the at least one of recess 260 includes two recesses 260A-B disposed in a non-uniform shape and a non-uniform orientation through the bottom surface 180. It will also be appreciated that the recesses may be in a uniform shape and/or uniform orientation through the bottom surface 180. In at least one embodiment, the at least one recess 260 forms at least one protrusion 280 on the bottom surface 180. In at least one embodiment, the at least one protrusion 280 may be biased towards the proximal end 120. In at least one embodiment, the at least one protrusion 280 may be biased towards the distal end 140. For example, as shown in FIG. 3, the cord tensioning and securing device 100 includes protrusion 280A that is biased towards the distal end 140, and includes protrusion 280B that is biased towards the proximal end 120.

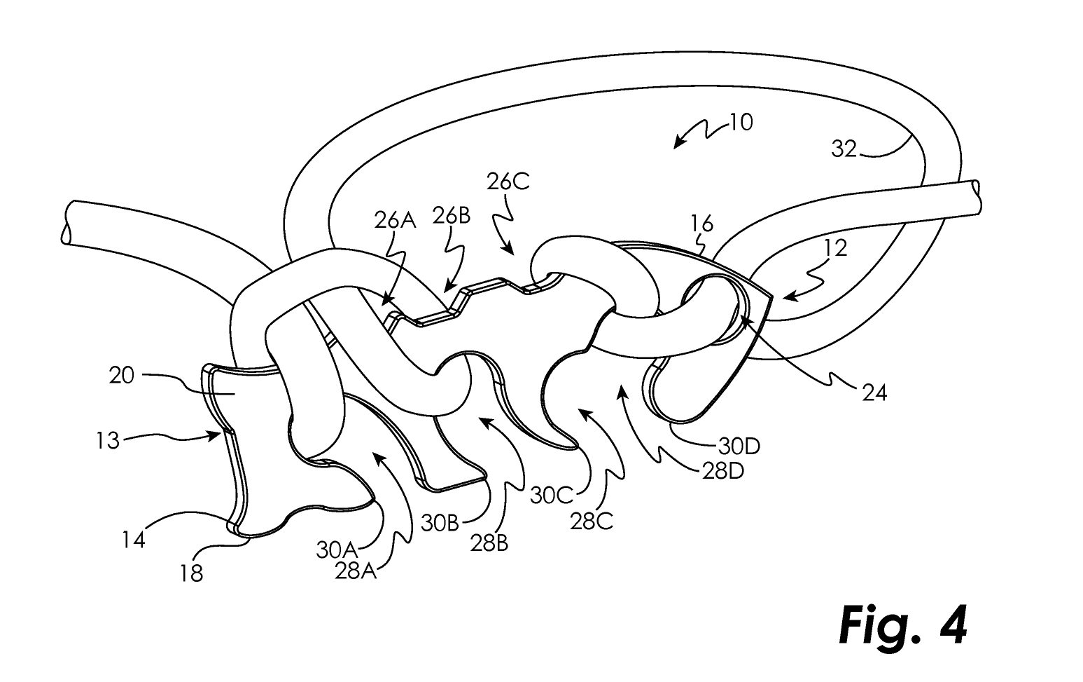

As illustrated in FIG. 4, a cord 32 may be wrapped around the cord tensioning and securing device 10 by coming into contact with one or more of the at least one indentations 26, penetrating one or more of the at least one recesses 28, and pulled until a desired tension is obtained. The cord 32 may also penetrate the at least one aperture 24, depending on the need of the application.

It will be appreciated that a cord 32 may be wrapped, in several configurations, around the at least one indentation 26, through the at least one recess 28, and through the at least one aperture 24 to provide an alternate means of securing and tightening the cord to or around other objects.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A cord tensioning and securing device comprising:
an elongated body comprising:
a proximal end;
a distal end;
a top surface;
a bottom surface;
a left surface; and
a right surface;
at least one indentation disposed on the top surface configured to allow at least a portion of a cord to be engaged therein; and
at least one recess disposed through the bottom surface configured to allow at least a portion of a cord to be engaged therein.

2. The cord tensioning device of claim 1 further comprising at least one aperture disposed in the elongated body.

3. The cord tensioning device of claim 1, wherein the elongated body comprises a length dimension extending between the proximal end and the distal end, wherein the length dimension is less than or equal to approximately 3.0 inches.

4. The cord tensioning device of claim 1, wherein the elongated body comprises a height dimension extending between the top surface and the bottom surface, wherein the height dimension is less than or equal to approximately 1.5 inches.

5. The cord tensioning device of claim 1, wherein the elongated body comprises a width dimension extending between the left surface and the right surface, wherein the width dimension is less than or equal to approximately 0.5 inch.

6. The cord tensioning and securing device of claim 1, wherein the at least one recess forms at least one protrusion on the bottom surface.

7. The cord tensioning and securing device of claim 6, wherein the at least one protrusion is biased towards the proximal end.

8. The cord tensioning and securing device of claim 6, wherein the at least one protrusion is biased towards the distal end.

9. The cord tensioning and securing device of claim 2, wherein the at least one aperture penetrates through the left surface and the right surface.

10. The cord tensioning and securing device of claim 9, wherein the at least one aperture is disposed in proximity to the proximate end.

11. The cord tensioning and securing device of claim 9, wherein the at least one aperture is disposed in proximity to the distal end.
